(19) United States
(12) Patent Application Publication
(10) Pub. No.: US 2006/0160928 A1
(43) Pub. Date: Jul. 20, 2006

(54) Thermoformed polystyrene products

(76) Inventors: Christopher S. Cleveland, Newport, KY (US); Alexander C. Bushman, Loveland, OH (US); Richard A. Tedford JR., Loveland, OH (US)

Correspondence Address: INTERNATIONAL PAPER COMPANY, 6285 TRI-RIDGE BOULEVARD, LOVELAND, OH, 45140, US

(21) Appl. No.: 11/037,869

(22) Filed: Jan. 18, 2005

(51) Int. Cl. C08K 9/00

(52) U.S. Cl. 523/200; 264/46.8

(57) ABSTRACT

A thermoformed food service product is disclosed. The thermoformed food service product comprises a polystyrene, a filler material, and a minor portion of additive. The polystyrene can be selected from the group consisting of crystal polystyrene, high impact polystyrene, and styrene-butadiene copolymers. The filler material can be selected from the group consisting of calcium carbonate, talc, mica, glass microspheres, plastic microspheres, titanium dioxide, silica, cellulose fibers, and any combinations thereof. The filler material can be coated with a compatibilizer. The filler material can be coated with a surfactant. The additive can be a coloring agent. The thermoformed food service product can be a container or other disposable food service product. The thermoplastic product described herein consists of a major portion and a minor portion. The major portion can be greater than about 95% by weight of the thermoplastic product and the minor portion can be less than about 5% by weight of the thermoplastic product. The major portion consists essentially of a high impact polystyrene and a filler material. A method for making the thermoplastic product is also described.

### TECHNICAL FIELD

The present invention relates to thermoformed polystyrene products and methods for making such products. More particularly, the invention relates to products made from a high impact polystyrene composite material.

### BACKGROUND

Disposable food service containers, particularly cups and bowls with corresponding lids are often made from a diverse variety of thermoplastic materials. It is widely known that inexpensive materials are desired to be employed in the manufacture of such products since these particular disposable food service products are typically discarded after a single use. Consequently, consumers desire to pay a minimum price for these products while still receiving a high quality product. Typically materials such as low-density polyethylene, polypropylene, polystyrene and other plastic materials are utilized in the manufacture and construction of high quality, disposable food service products.

In recent years the prices of commodity plastics have increased dramatically with corresponding increases in raw material costs. Some thermoplastic materials such as in the case of polystyrene products including crystal polystyrene, high impact polystyrene (HIPS), and styrene-butadiene copolymers have noticed an increase in both ethylene and benzene which are the main constituent raw materials for polystyrene. The price increases of ethylene and benzene have caused the corresponding prices of polystyrene products to increase at a faster rate than most comparable polyolefins like polyethylene and polypropylene. As a result many food service container manufacturers have been forced to identify ways to achieve cost reductions in their products. The cost of the constituent materials for such food service products can be reduced in three ways: (1) reducing the amount of plastic used; (2) using low-cost fillers; (3) a combination of these two methods. Nonetheless, with the ever-increasing cost of plastic materials, the manufacturers of disposable food service products continue to search for ways to make high quality products at a lower cost.

### SUMMARY

One embodiment of the present invention provides, a thermoformed foodservice product. The thermoformed food service product comprises a polystyrene at greater than about 65% by weight, a filler material at less than about 30% by weight, and a minor portion of additive at less than about 5% by weight. The polystyrene is selected from the group consisting of crystal polystyrene, high impact polystyrene, and styrene-butadiene copolymers. The polystyrene is from about 75% to about 90% by weight. The filler material is selected from the group consisting of calcium carbonate, talc, mica, glass microspheres, plastic microspheres, titanium dioxide, silica, cellulose fibers, and any combinations thereof. The filler material is from about 3% to about 25% by weight. The filler material can be coated with a compatibilizer. Also, the filler material can be coated with a surfactant. The surfactant can be stearic acid or any chemical derivative thereof. The additive can be a coloring agent in the form of a color concentrate or master batch. The thermoformed foodservice product can have a thickness of less than about 2.54 mm. Additionally, the thermoformed foodservice product can be a container.

In another embodiment of the present invention a thermoplastic product consisting essentially of a major portion and a minor portion is described. The major portion can be greater than about 95% by weight of the thermoplastic product and the minor portion can be less than about 5% by weight of the thermoplastic product. The major portion consists essentially of a high impact polystyrene of from about 75% to about 85% by weight and a filler material of less than about 25% by weight. The filler material is selected from the group consisting of calcium carbonate, talc, mica, glass microspheres, plastic microspheres, titanium dioxide, silica, cellulose fibers, and any combinations thereof. The filler material is from about 3% to about 25% by weight. The filler material is coated with a surfactant. The surfactant can be a stearic acid or any chemical derivative thereof. The minor portion comprises an additive of less than about 5% by weight. The additive is a coloring agent in the form of a color concentrate or master batch. The major portion can be about 98% and the minor portion can be about 2%. The thermoplastic food service product can be a container having a thickness of less than about 0.64 mm.

In still another embodiment of the present invention a method for making a thermoplastic product is provided. The method comprises creating a master batch for the thermoplastic product including a high impact polystyrene, a filler material, and a coloring agent. The method includes extruding the master batch through an extruder forming an extrudate consisting essentially of a high impact polystyrene of from about 75% to about 85% by weight, a filler material of less than about 25% by weight, and a coloring agent of less than about 2% by weight. The method also includes thermoforming the extrudate into a thermoplastic product. The filler material is selected from the group consisting of calcium carbonate, talc, mica, glass microspheres, plastic microspheres, titanium dioxide, silica, cellulose fibers, and any combinations thereof.

The details of one or more embodiments are set forth in the accompanying drawings and the description below.

### BRIEF DESCRIPTION OF THE DRAWINGS

While the specification concludes with claims particularly pointing out and distinctly claiming the present invention, it is believed that the present invention will be better understood from the following description in conjunction with the accompanying drawing figures wherein:

FIG. 1 is a perspective view from the bottom of an exemplary thermoformed product representing the present invention in the form of a lid;

FIG. 2 is a cross-sectional view of a combination of exemplary thermoformed products representing the present invention in the form of a lid engaged with a drinking cup; and

FIG. 3 is a schematic illustration of a process for making the thermoformed products of the present invention.

### DETAILED DESCRIPTION

In this detailed description of the present invention, any patent or non-patent literature referenced herein and the disclosure contained therein is intended to be and is hereby incorporated by reference. All numerical ranges and amounts are understood to be modified by the term “about”, which shall have the intended meaning that all such ranges or amounts are approximately or substantially the value indicated. An indication that a numerical range or amount is greater than or less than is also understood to include values that are approximately or substantially equal to the given numerical range or amount.

In one embodiment of the present invention, a thermoformed polystyrene product is described. An exemplary embodiment of such a thermoformed polystyrene product is a food service product. The words “food service”, as used herein, simply relates to or is involved with the handling, preparation, manufacture, provision, or serving of foods or beverages. Foods are understood to be any substance ingested for nourishment and are commonly distinguished from beverages since foods are substantially solid substances. A beverage on the other hand can be any drinkable liquid including water.

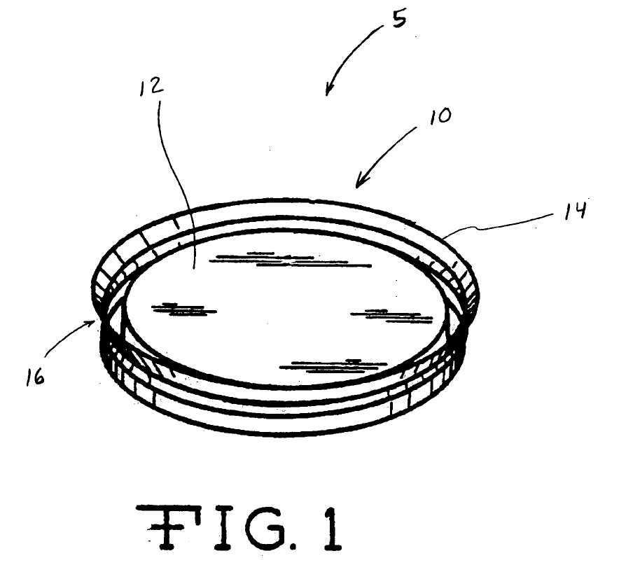

Referring now to FIG. 1, in which is shown a perspective view from the bottom of an exemplary thermoformed polystyrene product 5 in the form of a food service product represented as a lid 10 for a beverage container such as a drinking cup 20. The lid 10 is circular in shape with a substantially flat central cover portion 12 and a downwardly depending and outwardly curved annular skirt 14. The outer peripheral edge 16 of the lid 10 is configured to make a snap fit engagement. In one embodiment, the lid 10 is formed from a thin sheet of thermoplastic material. The thin sheet has a caliper, which determines the thickness of the corresponding food service product. In one embodiment, the thickness is less than about 2.54 mm. In another embodiment, the thickness is greater than about 0.1 mm and less than about 0.64 mm. In still another embodiment, the thickness is greater than about 0.76 mm and less than about 2.03 mm.

The word container is used as a reference to an article that is used to contain a substance. For example, a coffee cup is used to contain coffee. Examples of typical containers can be, but are not limited to, a cup, glass, bowl, box, pitcher, bottle, bucket, plate, tray, dish, platter, vase, holder, cover, cap, lid, top, sheet, closure, pan, sleeve, case or other similar article.

Food service products other than containers can be made in accordance with the present invention. For example, a utensil is a food service product that is not a container. Examples of typical utensils can be, but are not limited to, a fork, knife, spoon, pair of tongs, spatula, cooking implement, or any other commonly utilized utensils. When referring generally to food service products, such products can be any article, implement, utensil, package, container, or other similar item used in or with food services along with any combinations of such items.

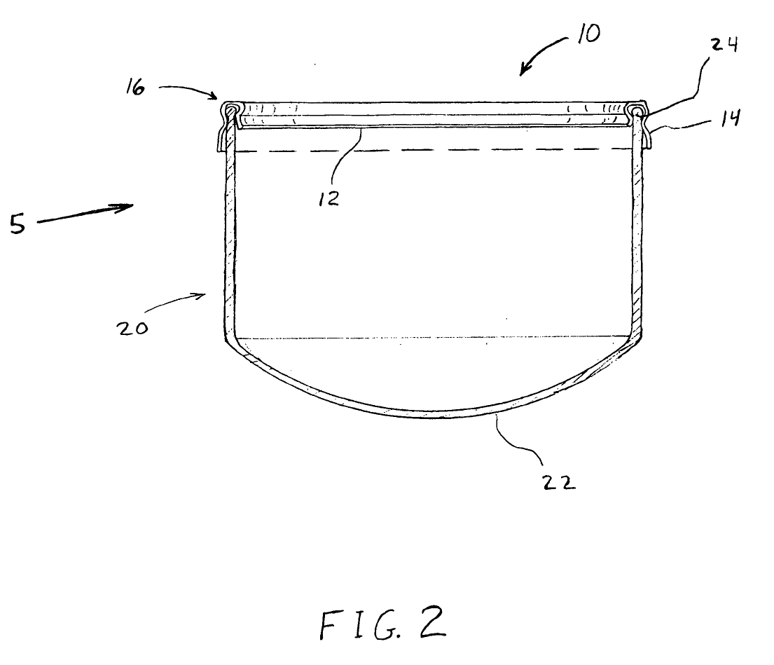

FIG. 2 illustrates a cross-sectional view of an exemplary thermoformed polystyrene product 5 in the form of a combination of food service products represented as two containers engaged with each other. This exemplary embodiment is shown as a lid 10 engaging a drinking cup 20. The drinking cup 20 is substantially cylindrical in shape with a closed bottom 22 and an open top. Cup 20 has an annular upper edge 24 surrounding the open top. The annular upper edge 24 engages with the outer peripheral edge 16 of lid 10. When lid 10 is in its operative position on cup 20 the open top of the cup 20 is sealed by lid 10. This snap fit engagement between the outer peripheral edge 16 of lid 10 and the annular upper edge 24 of cup 20 is to prevent spillage of the beverage contained within cup 20.

Food service products similar to those described are in great demand along with the foods and beverages contained within them. Consumers however are often very cost conscious and desire to consume the food or beverage with minimum expenses being allocated to paying for the food service product used to contain the food or beverage even though these food service products assist consumers in their enjoyment of the food or beverage itself.

While some food service products are intended for repetitive use, the food service products in accordance with the present invention are disposable. By disposable, it is meant that the food service products are intended for a single use and are typically disposed of by the consumer immediately after such use. Thus, all references to food service products herein are understood to be a reference to disposable food service products. Since the food service products of the present invention are discarded, it is very desirous to minimize the costs of the materials utilized while making them. To assure reduced costs, inexpensive thermoplastic materials that can be formed into various products is a preferred material to use in the manufacture of disposable food service products.

### The Polymer

Polystyrene is a preferred material for the manufacturer of the disposable food service products of the present invention. A polymer is a chemical compound or mixture of compounds formed by polymerization and consisting essentially of repeating structural units. The term styrene polymer refers to any solid homopolymer or copolymer of styrene having a softening point not less than 70° C. The term polystyrene, as used herein, includes crystal polystyrene, high impact polystyrene (HIPS), and styrene-butadiene copolymers. Polystyrene is a styrene polymer, which is a thermoplastic that has good physical and electrical insulating properties. Thermoplastic refers to plastics that are capable of softening when heated and of hardening again when cooled. Thermoplastics are made from polymers. Polymers are rarely used alone, fillers and additives are used to enhance the appearance, improve the strength, and change the characteristics of different thermoplastics.

Polystyrene can be mixed or combined with other materials to form a composite. The food service product of the present invention is made from a composite of polystyrene and a filler material. In particular, the thermoplastic material described herein has a major portion that consists substantially of polystyrene resin and a filler material and the thermoplastic material has a minor portion that comprises other additives.

The term high impact polystyrene broadly comprises a styrene polymer that includes a toughening agent such as an elastomer polymer wherein the elastomer polymer is present in discreet particles disbursed in a thermoplastic matrix of the styrene polymer. Incorporation of elastomers into styrene polymers increases the impact strength of the polymer. Incorporation of the elastomer into the styrene polymer may broadly be accomplished by graft copolymerization or by mechanical mastication of a mixture of elastomer and styrene polymer to form a high impact polystyrene using methods well known in the art such as, for example, that disclosed in U.S. Pat. No. 4,049,595.

High impact polystyrene can also be a polystyrene and polybutadiene or polyisoprene mixture that has much better impact resistance than normal polystyrene. High impact polystyrene is often more expensive than normal polystyrene. A commercially available high impact polystyrene is Styron® and Styron A-Tech® high impact polystyrene resins which are commercially available from The Dow Chemical Company. These high impact polystyrene resins are well suited for a variety of fabrication methods including injection molding, blow molding, extrusion and thermoforming.

### The Filler

The invention described herein has a major portion that consists essentially of filler material and polystyrene. The major portion is substantially all or is a large part of the whole thermoplastic material. In one embodiment of the invention, the major portion is greater than about 95% by weight of the thermoplastic product. In another embodiment, the major portion is about 98% by weight. A filler material is included in the major portion of the thermoplastic material and the filler is combined with the polystyrene. These two constituents, filler and polystyrene, constitute the major portion. In one embodiment of this invention, the major portion consists essentially of a high impact polystyrene with a filler material of calcium carbonate. In an embodiment of this invention, the polystyrene can be from about 75% to about 90% by weight. In another embodiment, the polystyrene can be greater than about 65% by weight. In still another embodiment of the invention, a filler material can be less than about 25% by weight. In a further embodiment of the invention, the filler material can be less than about 30% by weight. In an even further embodiment of the invention, the filler material can be from about 3% to about 25% by weight.

The word filler as used herein is a substance added to another in order to increase bulk, weight, viscosity, opacity or strength or some other characteristic of the substance. Examples of preferable filler materials are calcium carbonate, talc, mica, glass microspheres, plastic microspheres, titanium dioxide, silica, cellulose fibers, and any combinations thereof. Some examples of suitable filler materials which may be used in the present invention are well known in the art and include filler materials such as calcium carbonate, calcium sulfate, aluminium oxide and hydrates thereof, clay, aluminum silicate, silica, talc, asbestos fibers, vermiculite, wollastonite, and glass fibers; as well as naturally derived fillers such as saw dust, peanut shell husks and other nut shell waste products, carbon black and other pigments; as well as fibrous fillers such as cellulosic, polyester, or acrylic fibers. Even mixtures of these fillers may be used, for example, a mixture of mineral filler and a naturally derived item or even mixtures of items such as glass beads with calcium carbonate may be a suitable filler material.

In order to improve the mixing of the filler with the polystyrene, a surfactant can be used. A surfactant is a surface-active substance such as one that will allow diverse constituents to mix in a more homogeneous manner. One exemplary surfactant that can be used to coat the filler material is stearic acid or chemical derivatives of stearic acid. Such a surfactant is used in order to enhance the mixing of the filler material with the polystyrene in a master batch.

In addition to the use of a surfactant, a compatibilizer may also be used to improve mixing or compatibility of the filler with the polystyrene. A compatibilizer is used to reduce interfacial tension between the polystyrene and the filler material. Compatibilizers behave in much the same manner as surfactants and are typically used in the plastics industry to help make similar or dissimilar materials mix. In the present invention, use of a compatibilizer will help to assure proper mixing of the filler, polystyrene, and any other materials.

It can be seen that when utilizing a filler material with a polystyrene resin the resulting material costs can be decreased while the physical properties are enhanced. Both of these characteristics are impacted by the present invention in a very positive manner. For example, material costs can be decreased significantly when utilizing high impact polystyrene with a filler material such as by using calcium carbonate. By way of example, if the average market price for high impact polystyrene is about $0.62 to $0.70 per pound and the average market price for calcium carbonate is about $0.10 to $0.20 per pound, the overall product cost can be decreased by incorporating some of the calcium carbonate filler material into the high impact polystyrene. An exemplary thermoplastic material comprised of high impact polystyrene and calcium carbonate wherein the calcium carbonate is at about 15% by weight, reduces the cost since the average cost of such a composite material would be about $0.54 to $0.63 per pound.

Filler materials can also improve certain physical properties such as modulus of elasticity, tensile strength, and stiffness of the particular material. Improvements in these physical properties can lead to improved product performance. The addition of some filler materials such as when adding calcium carbonate filler material to high impact polystyrene increases the modulus as well as flexural strength. The modulus and flexural strength are both measures of the stiffness of the thermoplastic material. Improvements in these physical properties can have a significant impact on the way a product functions. For example, a food service product such as a cup 20 when snap fitted or engaged with another food service product such as a lid 10, the tightness of this fit can be improved. In other words, the lid 10 will form a more leak-tight seal with the cup 20 because of the improved physical properties such as increased stiffness. Even if the cup 20 were made of polycoated paper and the lid 10 made of a thermoplastic material in accordance with the present invention, there would still be a better fit between the lid 10 and the paper cup 20 itself.

### The Additives

There is also a minor portion in the thermoplastic material of the invention described herein. That minor portion is a very small part of the whole thermoplastic material. The minor portion is comprised of certain additives. In one embodiment of the invention, the minor portion is less than about 5% by weight of the thermoplastic material. In another embodiment, the minor portion can be less than about 2% by weight. An additive is a substance added to another in a relatively small amount to impart or improve desirable properties or to suppress undesirable properties. The master batch of high impact polystyrene and filler materials can have a minor portion of additives added thereto. Such additives may include for example, antioxidants, dye, fire resistant materials, mold release agents, colorants, and other materials designed to improve the processibility of the polymer or the properties of the thermoplastic product. Such additives can be added directly into the master batch.

A colorant or coloring agent is an additive that can be in the minor portion. In one embodiment, an additive, such as a coloring agent, is about 2% by weight and in another embodiment it can be less than about 2% by weight. Various coloring agents can be utilized in order to make the food service product any desired color. The coloring agent can be in the form of a color concentrate or master batch. One such coloring agent is titanium dioxide, which is used to make a product that is white in color. Other coloring agents include, for example, carbon black, which is used to make a product that is black in color. Food service products can be made with the coloring agent omitted or the food service products can even be translucent.

### The Process

Thermoplastics are plastics that soften or melt when they are heated and regain their rigidity when cool. Consequently, a variety of processes exist for establishing or changing the shape of thermoplastics by exploiting this property. Some well known processes include line bending, dip coating, blow molding, injection molding, vacuum forming, dome blowing, rotational molding, extrusion, and thermoforming.

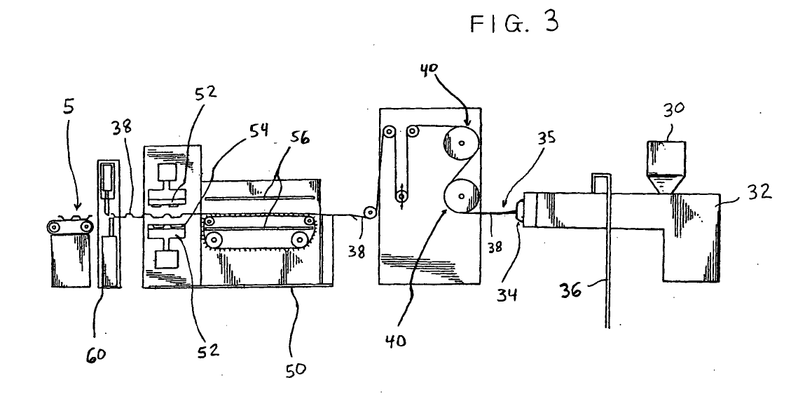

Referring now to FIG. 3, in which is shown an illustration of an extrusion process, which is part of the process for making the thermoformed products of the present invention. The master batch is fed into a hopper 30. The hopper 30 acts as the feed mechanism that introduces the master batch into the extruder 32. To extrude is to shape by forcing (force, press, or push out) through a die 34. The extruder 32 can be a typical screw type extruder 32 that forces out the extrudate 35 in the form of a continuous sheet 38 of thermoplastic material. The extrudate is extruded through the die 34. The extrudate is the extruded substance that results from extrusion. In an alternative embodiment a volatile or other type additive or agent can be introduced through feeder duct 36. Extrusion is a high volume, continuous production technique that utilizes relatively unrefined raw materials.

The master batch is a mix or mixture of raw materials including at least one substance mixed into the thermoplastic matrix of polystyrene constituents. The master batch is formulated by polystyrene constituents that can be granular and are fed into a hopper 30 and then through the extruder 32. When the extruder 32 extrudes the extrudate or melt through a die 34, the extrudate adopts the shape of the die 34. The extrudate can be cooled upon passing through rollers 40, which can also be used to form a pattern or texture into the continuous sheet 38 of extrudate.

The master batch of high impact polystyrene may be prepared by any suitable method wherein the high impact polystyrene can be melted or fluxed and the other components can be mixed within and disbursed in the molten high impact polystyrene. Methods for mixing a master batch and extrusion are well known in the art such as, for example, that disclosed in U.S. Pat. No. 4,111,349.

Thermoforming is to give a final shape to the thermoplastic material with the aide of heat and usually pressure in a molding process. Such thermoforming processes for shaping or molding thermoplastics into various useful products by forming a heated continuous sheet 38 of thermoplastic material over a cavity 54 and then having the continuous sheet 38 take the shape of the cavity 54 are well known in the art. Commercially available machinery for such processes is designed in such a way that the continuous sheet 38 of thermoplastic material is fed through an oven 56 and heated to bring the continuous sheet 38 to a thermoformable temperature. Alternatively, the extrudate in the form of a continuous sheet 38 can come directly from the extruder 32 and be brought to the proper thermoforming temperature by means of a series of rollers 40, which can either be heated or cooled. In either case, the thermoforming station 50 is outfitted with molds 52 having cavities 54 of the desired shape. The continuous sheet 38 of heated thermoplastic material is either draped over the mold 52 or vacuum formed into the cavity 54 and thus takes on the predetermined product shape from the mold 52 or cavity 54. The thermoplastic product is formed from the continuous sheet 38 which is then cut or separated into individual thermoformed polystyrene products 5 at cutting station 60. The individual thermoformed polystyrene products 5 can be in the shape of a food service product. One preferred embodiment is a food service product in the form of a lid 10, drinking cup 20, or the like.

In another embodiment of the present invention the extrusion process is capable of using “regrind” material from the thermoforming process. During the process of forming the thermoplastic polystyrene product 5, only a portion of the feed material used in the process is converted into usable products. The remainder goes into trim or waste such as collected during cutting at cutting station 60. Such trim or waste can be reground and mixed with the virgin feedstock or master batch and fed back into hopper 30.

As previously described the stiffness of the food service product increases when made in accordance with the present invention. For example, when a lid 10 made in accordance with the present invention is placed on a disposable polycoated paper cup 20 there is an improved fit between the lid 10 and the paper cup 20. This improved fit significantly reduces or decreases the amount of leakage between the annular upper edge 24 of the cup 20 and the peripheral edge 16 of the polystyrene composite lid 10. This improvement in fit is exemplified in the following Table 1.

TABLE 1

| | Composition | Sheet Thickness | Leakage Rate |
|---|---|---|---|
| Sample No. | (% by weight) | (mm) | (grams/20 seconds) |
| SL-1 | HIPS - 98% | 0.432 | 1.28 |
| | White Master | | |
| | batch - 2% | | |
| SL-2 | HIPS - 98% | 0.406 | 1.44 |
| | White Master | | |
| | batch - 2% | | |
| SL-3 | HIPS - 83% | 0.406 | 0.97 |
| | CaCO₃ - 15% | | |
| | White Master | | |
| | batch - 2% | | |
| SL-4 | HIPS - 78% | 0.394 | 0.38 |
| | CaCO₃ - 20% | | |
| | White Master | | |
| | batch - 2% | | |

The testing illustrated in Table 1 was conducted to obtain the leakage rate in grams over a 20 second period of time. The leak flow rate testing was performed by taping over the vent hole in the polystyrene composite lid 10 and then placing the lid 10 on a new 400/450 ml (16 ounce) paper cup. Representative of the cup utilized was a 16-ounce disposable polycoated paper cup commercially available as product number DMR-16 from International Paper Food Service Business. The paper cup was filled with hot water. The hot water was at a temperature of approximately 80° C. The vent hole on the lid 10 was positioned such that it was opposite from the seam in the sidewall of the paper cup. With the side seam of the paper cup pointing down, the cup was tilted to a “pouring position”. This testing was conducted utilizing approximately a 45° angle of tilt or incline of the paper cup to place it in a “pouring position” so that the water would be against the annular upper edge 24 of the cup and the peripheral edge 16 of the lid 10. The water leakage was collected for a period in time of 20 seconds and then the weight of the water collected was determined. The thickness of the sheet of thermoplastic polystyrene composite material forming the lid 10 is also measured and listed in the column titled “Sheet Thickness.” Four samples were tested. Sample #1 included what can be considered a baseline lid 10 having a composition consisting substantially of high impact polystyrene (98% by weight) without filler and a standard sheet thickness for the lid 10. Sample #2 involved the same material as Sample #1 but using a thinner caliper lid 10. Sample #3 was a composite substantially composed of only high impact polystyrene and calcium carbonate filler with a minor portion of White Master batch. Sample #4 was a different composition of the thermoplastic material comprised substantially of only high impact polystyrene and calcium carbonate filler material with a minor portion of White Master batch and also a thinner caliper lid 10 was utilized. The White Master batch utilized in this test included an additive that was a titanium dioxide as the coloring agent placed in the master batch. It is evident from Table 1 that the leakage rate, when utilizing the composite thermoplastic polystyrene material made in accordance with the present invention having a major portion consisting essentially of high impact polystyrene and filler, was significantly reduced from the sample made substantially of high impact polystyrene alone.

An embodiment of a lid 10 for a drinking cup has been used as an exemplary illustration of a typical food service product throughout this detailed description. However, the products embodied in the present invention are not limited only to such food service products. Products in accordance with the present invention can be any thermoformed polystyrene product including, for example, articles useful for health care, beauty care, pharmaceuticals, medical procedures, automotive components, storage devices, transportation, house wares, clothing, consumer goods, home appliances, electric components, and the like. Consequently, any of the above-identified product categories can be interchanged with the words “food service” throughout this description of the present invention.

While particular embodiments of the present invention have been illustrated and described, it would be obvious to those skilled in the art that various additional changes and modifications can be made without departing from the spirit and scope of the present invention. It is therefore intended to cover in the appended claims all such changes and modifications that are within the scope of this invention.

What is claimed is:

1. A thermoformed foodservice product comprising:
a polystyrene at greater than about 65% by weight, a filler material at less than about 30% by weight, and a minor portion of additive at less than about 5% by weight.

2. The thermoformed foodservice product of claim 1 wherein the polystyrene is selected from the group consisting of crystal polystyrene, high impact polystyrene, and styrene-butadiene copolymers.

3. The thermoformed foodservice product of claim 1 wherein the polystyrene is from about 75% to about 90% by weight.

4. The thermoformed foodservice product of claim 1 wherein the filler material is selected from the group consisting of calcium carbonate, talc, mica, glass microspheres, plastic microspheres, titanium dioxide, silica, cellulose fibers, and any combinations thereof.

5. The thermoformed foodservice product of claim 1 wherein the filler material is from about 3% to about 25% by weight.

6. The thermoformed foodservice product of claim 1 wherein the filler material is coated with a compatibilizer.

7. The thermoformed foodservice product of claim 1 wherein the filler material is coated with a surfactant.

8. The thermoformed foodservice product of claim 7 wherein the surfactant is selected from the group consisting of stearic acid, chemical derivative of stearic acid, and any combinations thereof.

9. The thermoformed foodservice product of claim 1 wherein the additive is a coloring agent in the form of a color concentrate or master batch.

10. The thermoformed foodservice product of claim 1 having a thickness wherein the thickness is less than about 2.54 mm.

11. The thermoformed foodservice product of claim 1 wherein the product comprises a container.

12. A thermoplastic product consisting essentially of a major portion and a minor portion wherein the major portion is greater than about 95% by weight of the thermoplastic product and the minor portion is less than about 5% by weight of the thermoplastic product, the major portion consisting essentially of a high impact polystyrene of from about 75% to about 85% by weight and a filler material of less than about 25% by weight, and the minor portion comprising an additive of less than about 5% by weight.

13. The thermoplastic product of claim 12 wherein the filler material is selected from the group consisting of calcium carbonate, talc, mica, glass microspheres, plastic microspheres, titanium dioxide, silica, cellulose fibers, and any combinations thereof

14. The thermoplastic product of claim 13 wherein the filler material is from about 3% to about 25% by weight.

15. The thermoplastic product of claim 13 wherein the filler material is coated with a surfactant.

16. The thermoplastic product of claim 15 wherein the surfactant is stearic acid, chemical derivative of stearic acid, and any combinations thereof.

17. The thermoplastic product of claim 12 wherein the additive is a coloring agent selected from the group consisting of titanium dioxide, carbon black, and any combinations thereof.

18. The thermoplastic product of claim 12 wherein the major portion is about 98% and the minor portion is about 2%.

19. The thermoplastic product of claim 18 wherein the foodservice product is a container having a thickness of less than about 0.64 mm.

20. A method for making a thermoplastic product comprising the steps of:
Creating a master batch for the thermoplastic product including a high impact polystyrene, a filler material and a coloring agent;
Extruding the master batch through an extruder forming an extrudate consisting essentially of a high impact polystyrene of from about 75% to about 85% by weight, a filler material of less than about 25% by weight, and a coloring agent of less than about 2% by weight; and
Thermoforming the extrudate into a thermoplastic product.

21. The method for making the thermoplastic product of claim 20 wherein the filler material is selected from the group consisting of calcium carbonate, talc, mica, glass microspheres, plastic microspheres, titanium dioxide, silica, cellulose fibers, and any combinations thereof.
